(19) United States
(12) Patent Application Publication
(10) Pub. No.: US 2020/0017281 A1
(43) Pub. Date: Jan. 16, 2020

(54) THERMAL BAG

(71) Applicant: XIAMEN KINGQUEEN INDUSTRIAL CO., LTD., Xiamen, Fujian (CN)

(72) Inventor: Jinfei Dong, Xiamen (CN)

(21) Appl. No.: 16/162,344

(22) Filed: Oct. 16, 2018

(30) Foreign Application Priority Data
Jul. 13, 2018 (CN) 201821115730.6

(51) Int. Cl. B65D 81/38; A47J 41/00

(52) U.S. Cl. CPC B65D 81/3897; A45C 11/20; A47J 41/0066

(57) ABSTRACT

A thermal bag includes a thermal bag main body and a zipper. The thermal bag main body includes an accommodating portion and an opening portion. The accommodating portion is connected to the opening portion to form the thermal bag. The opening portion is formed with an opening. The opening is mounted with the zipper. Two support bars are interlaid between an outer layer fabric and an inner layer fabric of the opening portion at two sides of the zipper, respectively. The two support bars extend in the direction of the opening. When the zipper is unzipped, the two support bars cooperate with each other to brace the fabrics of the opening portion, so that the opening is formed in a stable shape, does not collapse and is more convenient for taking and placing articles.

### BACKGROUND OF THE INVENTION

### 1. Field of the Invention

The present invention relates to a thermal bag, and more particularly to a thermal bag with a convenient opening.

### 2. Description of the Prior Art

A thermal bag is widely used in daily life, especially in the field of takeout and medicine. Compared with an ordinary bag, the inner layer of the thermal bag is made of aluminum foil. Through PE cotton having thermal insulation function, the bag has the effect of short-term heat preservation, so as to hold various foods and maintain the temperature and freshness of the foods. The medical personnel may use the thermal bag for carrying some medicines that need to be kept in a constant temperature environment when going out.

In general, the thermal bag is made of Oxford fabric or nylon fabric, and the opening is relatively soft, which causes the shape of the opening to be irregular after the zipper is unzipped. It is inconvenient to take and place articles.

Accordingly, the inventor of the present invention has devoted himself based on his many years of practical experiences to solve these problems.

### SUMMARY OF THE INVENTION

The primary object of the present invention is to provide a thermal bag with a convenient opening. The opening has a shaping ability, thereby forming a stable shape and facilitating placement of articles.

In order to achieve the above object, the present invention adopts the following technical solutions.

A thermal bag comprises a thermal bag main body and a zipper. The thermal bag main body includes an accommodating portion and an opening portion. The accommodating portion is connected to the opening portion to form the thermal bag. The opening portion is formed with an opening. The opening is mounted with the zipper. Two support bars are interlaid between an outer layer fabric and an inner layer fabric of the opening portion at two sides of the zipper, respectively. The two support bars extend in the direction of the opening.

Preferably, the two support bars extend to a position beyond a side wall of the accommodating portion and are bent toward each other, directed to an end of the zipper.

Preferably, top shaping boards are interlaid between the outer layer fabric and the inner layer fabric of the opening portion for supporting the fabrics of the opening portion.

Preferably, the top shaping boards are foam boards.

Preferably, a side shaping board is interlaid between an outer layer fabric and an inner layer fabric around the accommodating portion for supporting the fabrics of the accommodating portion.

Preferably, the side shaping board is a foam board.

Preferably, a pair of handles is mounted on two sides of an outer wall of the accommodating portion.

With the above structure, when the zipper is zipped, the two support bars support the fabrics of the opening portion, so that the bag is formed with a relatively flat top surface. When the zipper is unzipped, the two support bars cooperate with each other to brace the fabrics of the opening portion, so that the opening is formed in a stable shape, does not collapse and is more convenient for taking and placing articles.

In addition, the top shaping boards increase the ability of the opening portion to be shaped while increasing the thermal insulation function.

### BRIEF DESCRIPTION OF THE DRAWINGS

FIG. 1 is a perspective view of the present invention;

FIG. 2 is a schematic view of the present invention in a closed state; and

FIG. 3 is a schematic view of the present invention in an open state.

### DETAILED DESCRIPTION OF THE PREFERRED EMBODIMENTS

Embodiments of the present invention will now be described, by way of example only, with reference to the accompanying drawings.

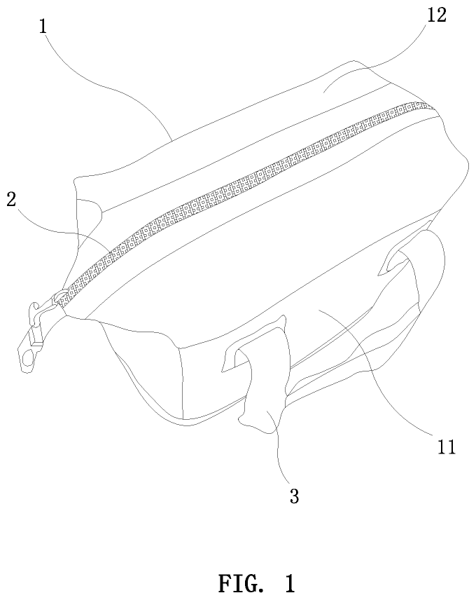

As shown in FIG. 1, a thermal bag comprises a thermal insulation main body 1 and a zipper 2. The thermal bag main body 1 is in the shape of a bag which is common in daily life, and includes an accommodating portion 11 and an opening portion 12. The accommodating portion 11 is connected to the opening portion 12, and the two cooperate with each other to form the thermal bag having an internal closed space.

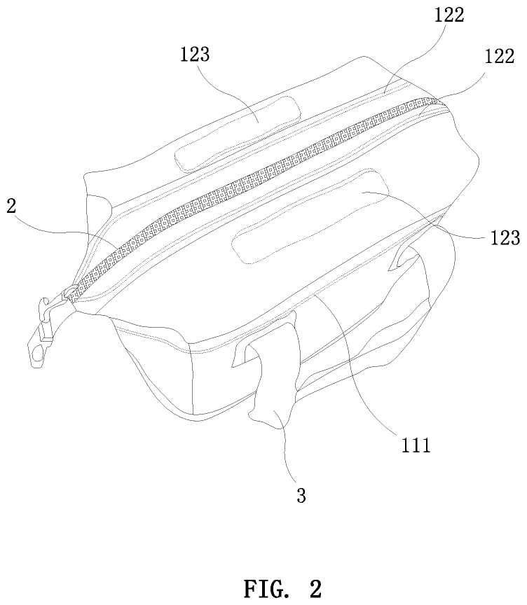

As shown in FIG. 2, a side shaping board 111 is interlaid between an outer layer fabric and an inner layer fabric around the accommodating portion 11, so that the accommodating portion 11 has a regular cylindrical shape, and the internal space is more suitable for placing articles, not in a state of chaos. A pair of handles 3 is mounted on two sides of the outer wall of the accommodating portion 11 for moving and carrying the thermal bag.

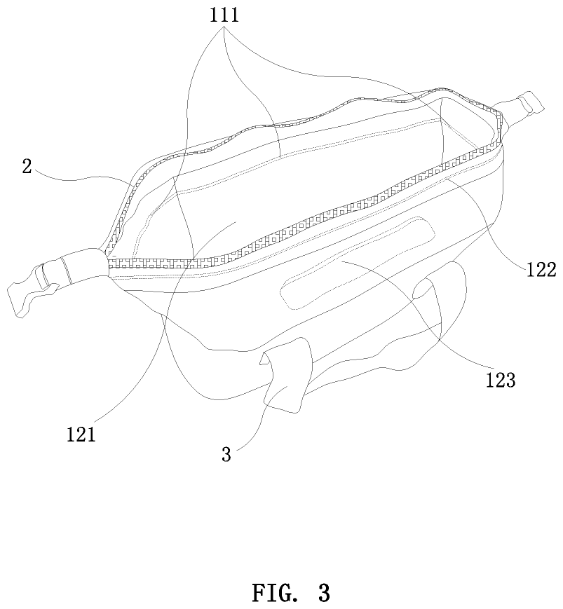

As shown in FIG. 3, the opening portion 12 is formed with an opening 121. The opening 121 is mounted with the zipper 2 for opening and closing the internal space of the thermal bag.

The improvement of the present invention is that two support bars 122 are interlaid between an outer layer fabric and an inner layer fabric of the opening portion 12 at two sides of the zipper 2, respectively. The two support bars 122 extend in the direction of the opening 121.

The two support bars 122 extend to a position beyond the side wall of the accommodating portion 11 and are bent toward each other, directed to the end of the zipper 2. The support bars 122 support the fabrics at the edge of the opening 121, such that the opening 121 has a certain shape.

Top shaping boards 123 for supporting the fabrics of the opening portion 12 are interlaid between the outer layer fabric and the inner layer fabric of the opening portion 12 below the support bars 122, respectively. The top shaping boards 123 can support most of the fabrics of the opening portion 12.

The shaping board may be a foam board which is common in life and is light and practical.

With the above structure, when the zipper 2 is zipped, the two support bars 122 support the fabrics of the opening portion 12, so that the bag is formed with a relatively flat top surface. When the zipper 2 is unzipped, the two support bars 122 cooperate with each other to brace the fabrics of the opening portion 12, so that the opening 121 is formed in a stable shape, does not collapse and is more convenient for taking and placing articles.

In addition, the top shaping boards 123 increase the ability of the opening portion 12 to be shaped while increasing the thermal insulation function.

Although particular embodiments of the present invention have been described in detail for purposes of illustration, various modifications and enhancements may be made without departing from the spirit and scope of the present invention. Accordingly, the present invention is not to be limited except as by the appended claims

What is claimed is:

1. A thermal bag, comprising a thermal bag main body and a zipper, the thermal bag main body including an accommodating portion and an opening portion, the accommodating portion being connected to the opening portion to form the thermal bag, the opening portion being formed with an opening, the opening being mounted with the zipper, characterized in that: two support bars are interlaid between an outer layer fabric and an inner layer fabric of the opening portion at two sides of the zipper respectively, and the two support bars extend in the direction of the opening.

2. The thermal bag as claimed in claim 1, wherein the two support bars extend to a position beyond a side wall of the accommodating portion and are bent toward each other, directed to an end of the zipper.

3. The thermal bag as claimed in claim 1, wherein top shaping boards are interlaid between the outer layer fabric and the inner layer fabric of the opening portion for supporting the outer and inner layer fabrics of the opening portion.

4. The thermal bag as claimed in claim 3, wherein the top shaping boards are foam boards.

5. The thermal bag as claimed in claim 1, wherein a side shaping board is interlaid between an outer layer fabric and an inner layer fabric around the accommodating portion for supporting the outer and inner layer fabrics of the accommodating portion.

6. The thermal bag as claimed in claim 5, wherein the side shaping board is a foam board.

7. The thermal bag as claimed in claim 1, wherein a pair of handles is mounted on two sides of an outer wall of the accommodating portion.
